(19) United States
(12) Patent Application Publication
(10) Pub. No.: US 2021/0022058 A1
(43) Pub. Date: Jan. 21, 2021

(54) HANDOVER AND RRC RE-ESTABLISHMENT DELAY IN 2-STEP RACH

(71) Applicant: QUALCOMM Incorporated, San Diego, CA (US)

(72) Inventors: Muhammad Nazmul ISLAM, Littleton, MA (US); Jing LEI, San Diego, CA (US)

(21) Appl. No.: 16/929,965

(22) Filed: Jul. 15, 2020

Related U.S. Application Data
(60) Provisional application No. 62/876,417, filed on Jul. 19, 2019.
(60) Provisional application No. 63/008,422, filed on Apr. 10, 2020.

(51) Int. Cl. H04W 36/08; H04W 74/08; H04W 56/00; H04W 74/02; H04W 76/27

(52) U.S. Cl. CPC H04W 36/08; H04W 74/0833; H04W 76/27; H04W 74/02; H04W 56/001

(57) ABSTRACT

A connection establishment procedure such as a handover or re-establishment procedure including a 2-step random access procedure may be completed within a defined time period. The defined time period may be measured from a handover command or a determination that a user equipment (UE) has lost a connection to a base station. The defined period of time may depend on one or both of a synchronization signal block (SSB) to random access channel (RACH) association period or a SSB to RACH association pattern period. The UE may receive a handover command from a serving cell. The UE may perform a handover in response to receiving the handover command or a re-establishment procedure in response to detecting the lost connection within the defined time period. One or more base stations may reserve resources for the connection establishment procedure during the defined time period.

This application claims priority to U.S. Provisional Application No. 62/876,417 titled “HANDOVER AND RRC RE-ESTABLISHMENT DELAY IN 2-STEP RACH,” filed Jul. 19, 2019 and U.S. Provisional Application No. 63/008,422 titled “HANDOVER AND RRC RE-ESTABLISHMENT DELAY IN 2-STEP RACH,” filed Apr. 10, 2020, both of which are assigned to the assignee hereof, and incorporated herein by reference in their entirety.

### BACKGROUND

### Technical Field

The present disclosure relates generally to communication systems, and more particularly, to random access (RACH) procedures for communication systems.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a non-transitory computer-readable medium, and an apparatus for performing a handover are provided. The method may include receiving a handover command from a serving cell. The method may include performing a handover to a target cell in response to the handover command within a first time period from the handover command. Performing the handover may include transmitting a physical random access channel (PRACH) preamble and a physical uplink shared channel (PUSCH) to the target cell. The first time period depends on one or both of a synchronization signal block (SSB) to random access (RACH) association period or a SSB to RACH association pattern period. The disclosure provides apparatuses and a non-transitory computer-readable medium for performing the method.

In another aspect, a method, a non-transitory computer-readable medium, and an apparatus for re-establishing a connection are provided. The method may include determining that the UE has lost a radio resource control (RRC) connection with a first cell. The method may include re-establishing the RRC connection within a first time period, wherein the first time period depends on one or both of a SSB to RACH association period or a SSB to RACH association pattern period. Re-establishing the RRC connection may include finding a new cell and transmitting a msgA to the new cell. The msgA includes a selected random access preamble on a PRACH and a msgA payload on a PUSCH. The disclosure provides apparatuses and a non-transitory computer-readable medium for performing the method.

In another aspect, a method, a non-transitory computer-readable medium, and an apparatus for re-establishing a connection are provided. The method may include receiving a RRC connection release with redirection command. The method may include releasing an RRC connection with a serving cell in response to the RRC connection release with redirection command. The method may include finding a new cell and transmitting a PRACH preamble and PUSCH to the new cell within a first time period. The first time period may depend on one or both of a SSB to RACH association period or a SSB to RACH association pattern period. The disclosure provides apparatuses and a non-transitory computer-readable medium for performing the method.

In another aspect, a method, a non-transitory computer-readable medium, and an apparatus for a network performing a handover are provided. The method may include transmitting, via a first serving cell, a handover command to a user equipment (UE). The method may include preparing a target cell to receive a msgA preamble and msgA PUSCH from the UE at the target cell within a first time period, wherein the first time period depends on one or both of a SSB to RACH association period of the target cell or a SSB to RAC association pattern period of the target cell.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with certain aspects of the present description.

FIG. 2A is a diagram illustrating an example of a first frame, in accordance with certain aspects of the present description.

FIG. 2B is a diagram illustrating an example of DL channels within a subframe, in accordance with certain aspects of the present description.

FIG. 2C is a diagram illustrating an example of a second frame, in accordance with certain aspects of the present description.

FIG. 2D is a diagram illustrating an example of a subframe, in accordance with certain aspects of the present description.

FIG. 3 is a diagram illustrating an example of a base station and user equipment (UE) in an access network, in accordance with certain aspects of the present description.

FIG. 4 is a message diagram showing example messages between a UE and base stations to establish a connection, in accordance with certain aspects of the present description.

FIG. 5 is a resource diagram showing example resource allocations having different periodicities, in accordance with certain aspects of the present description.

FIG. 6 is a flowchart of an example method of wireless communication for a UE performing a handover, in accordance with certain aspects of the present description.

FIG. 7 is a flowchart of an example method of wireless communication for a UE to re-establish a connection, in accordance with certain aspects of the present description.

FIG. 8 is a flowchart of an example method of wireless communication for a UE connect to a new cell following a release with redirection, in accordance with certain aspects of the present description.

FIG. 9 is a flowchart of an example method of wireless communication for a base station performing a handover, in accordance with certain aspects of the present description.

FIG. 10 is a schematic diagram of example components of the UE of FIG. 1, in accordance with certain aspects of the present description.

FIG. 11 is a schematic diagram of example components of the base station of FIG. 1, in accordance with certain aspects of the present description.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

A user equipment (UE) may establish a connection with a base station in various scenarios such as a handover or a connection re-establishment using a random access procedure. Timing may be important for such scenarios and the UE may be configured to perform the random access (RACH) procedure within a defined time period. Conventionally, a four-step RACH procedure has been used and the timing for establishing the connection has been based on the first message of the four-step RACH procedure, which may be referred to as msg1 or the RACH preamble.

Recently, a two-step RACH procedure has been proposed to reduce the time for performing a random access procedure in comparison to a four-step RACH procedure. In the two-step RACH procedure, the first message (msgA) of the two-step RACH procedure includes both a RACH preamble transmitted on a physical RACH (PRACH) and a RACH payload that may be transmitted on a physical uplink shared channel (PUSCH). Because resources may be reserved on both the PRACH and the PUSCH for the RACH procedure, defining the time period for connection establishment based on only the RACH resources may result in unrealistic or impossible time periods for completing the RACH procedure. For example, in cases where the PUSCH resources are not scheduled or are invalidated, the UE may not be ready to transmit the payload on PUSCH because no PUSCH resources are available.

In an aspect, the present disclosure provides for performing a connection establishment such as a handover or connection re-establishment within a time period that depends on a synchronization signal block (SSB) to RACH association pattern period. The SSB to RACH association pattern period may allow the UE to find a valid physical PRACH and PUSCH resource for the target cell. The time period may also depend on one or more of a SSB to msgA PRACH association period or a SSB to msgA PUSCH association pattern period. A base station (e.g., original serving cell or target cell) may reserve resources such as a contention free random access (CFRA) preamble and PUSCH resources during the time period for the UE to complete the connection establishment.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer. In an aspect, the term non-transitory computer-readable medium excludes transitory signals.

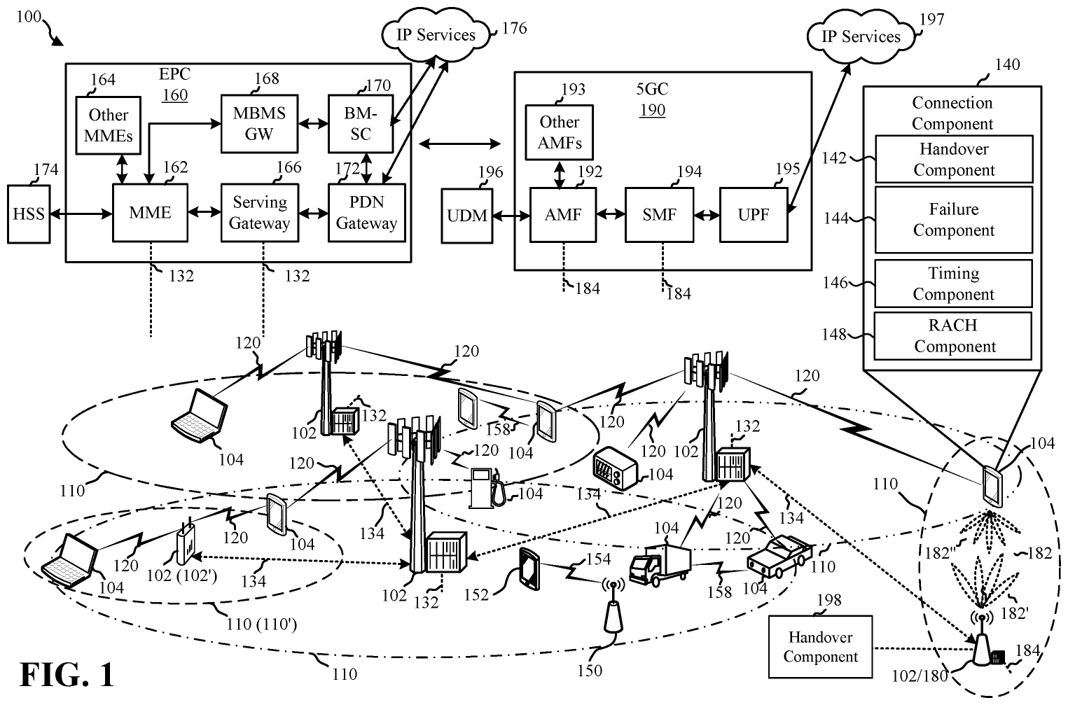

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

In an aspect, one or more of the UEs 104 may include a connection component 140 configured to establish a connection with a base station 102 or an associated cell. The connection component 140 may include a handover component 142 that detects a handover command and/or a failure component 144 that detects a loss of a connection with a serving cell. The connection component 140 may include a timing component 146 that determines a period of time for connecting to a cell based on a SSB to msgA PUSCH association period. The connection component 140 may include a RACH component 148 that performs a RACH procedure as part of a connection establishment such as a handover or connection re-establishment.

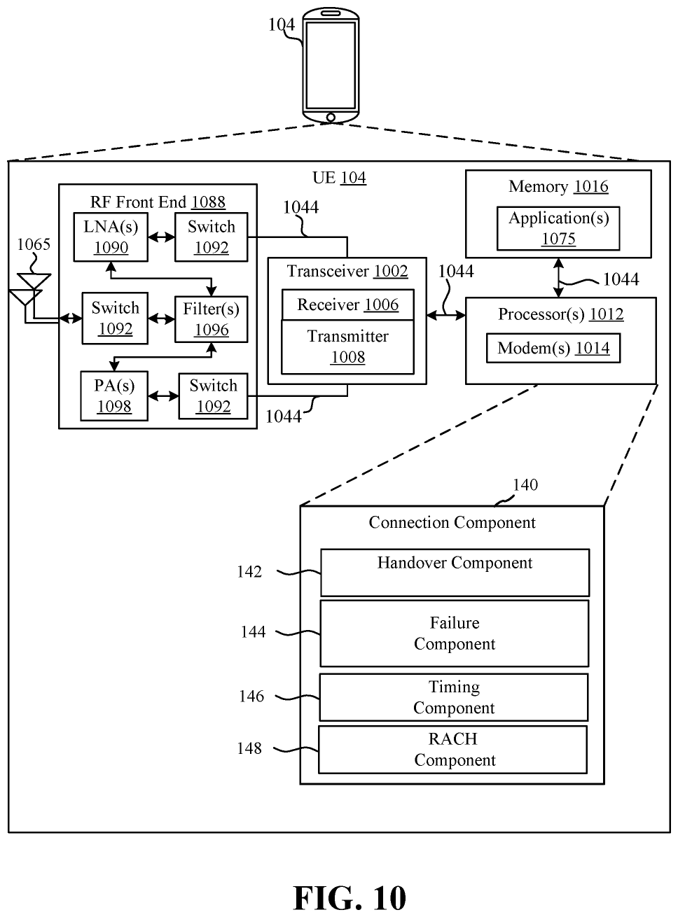

One or more of the base station 102 may include a handover component 198 that operates in communication with the connection component 140 to establish a connection between the base station 102 and the UE 104. As illustrated in FIG. 10, the handover component 198 may include a command component 1142 that transmits a handover command, a timing component 1144 that determines a time period to perform a handover, a RACH component 1146 that performs a 2-step random access procedure, and a backhaul component 1148 that communicates with another base station.

Although the following description may be focused on 5G NR, the concepts described herein may be applicable to other similar areas, such as LTE, LTE-A, CDMA, GSM, and other wireless technologies.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

A base station 102, whether a small cell 102′ or a large cell (e.g., macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ES S), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

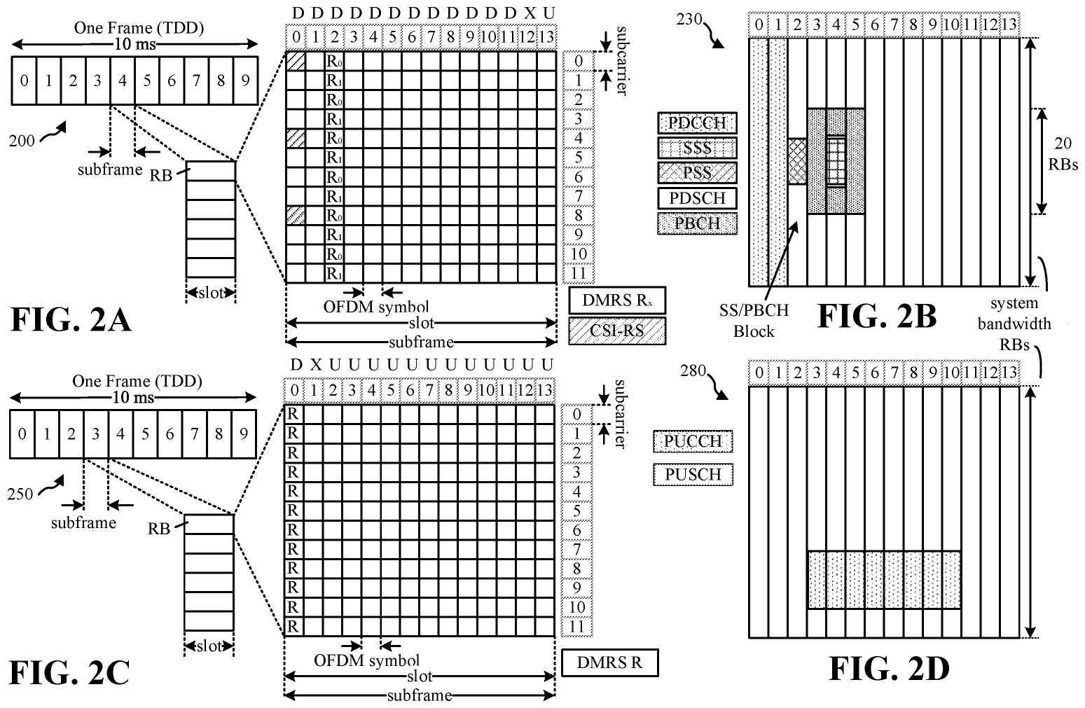

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

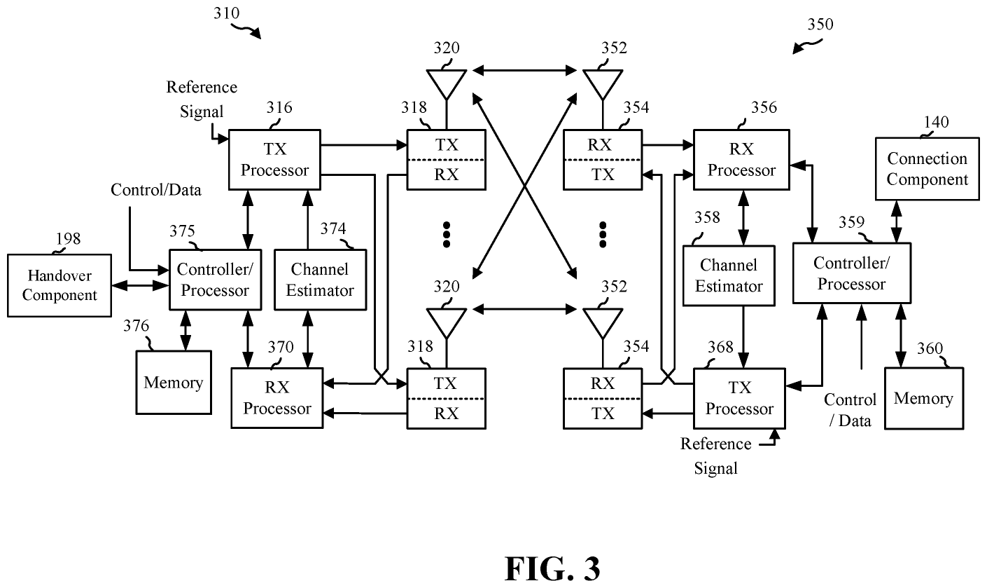

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the connection component 140 of FIG. 1.

At least one of the TX processor 316, the RX processor 370, and the controller/processor 375 may be configured to perform aspects in connection with the RACH component 198 of FIG. 1.

In the 3GPP 5G NR Release-15, a handover delay defines the gap between the time UE receives the RRC message from the serving cell and the time the UE becomes ready to start the transmission of the uplink PRACH preamble to the target cell. If contention free random access is configured, the target cell stores the CFRA preamble for the UE, at least, during the handover delay period. Similarly, a re-establishment delay defines a gap between the time the UE detects a failure condition and when the UE sends an uplink PRACH to the target cell.

In a two-step RACH procedure, the UE transmits both RACH preamble and payload to a base station (e.g., a gNB) before receiving a random access response from the gNB. Even during handover, for contention free random access, the gNB may have to reserve a RACH preamble and PUSCH grant, so that the target gNB can receive RACH preamble and payload from the UE. Accordingly, for a two-step RACH procedure, the handover delay may be defined as the gap between the time UE receives the RRC message from the serving cell and the time UE becomes ready to start the transmission of both the uplink msgA PRACH preamble and msgA PUSCH to the target cell. Similarly, the re-establishment delay may define the gap between the time the UE detects a failure condition and the time UE becomes ready to start the transmission of both the uplink msgA PRACH preamble and msgA PUSCH to the target cell.

As an example, a 2-step RACH for NR may have design objectives that include: 2-step RACH shall be able to operate regardless of whether the UE has a valid timing advance (TA) or not. The 2-step RACH is applicable to any cell size supported in Rel-15 NR. In 2-step RACH, multiple messages in legacy procedure in a single message. More specifically, msgA combines legacy msg1 and msg3 and msgB combines legacy msg2 and msg4. The msgA may include preamble and PUSCH carrying payload where the content of msgA includes the equivalent contents of msg3 of 4-step RACH. The content of msgB includes the equivalent contents of msg2 and msg4 of 4-step RACH.

For 5G NR, a handover between two cells operating on frequency range 1 (FR1-FR1) handover, handover delay is defined as a sum of a RRC procedure delay and an interruption time. The RRC procedure delay may refer to a maximum time to decode a handover command. The interruption time may include a time required to search the target cell (T_{search}), a time for fine time tracking and acquiring full timing information of the target cell (T_{Δ}), an interruption uncertainty in acquiring the first available PRACH occasion in the new cell (T_{IU}), and a defined additional period (e.g., 20 ms or 40 ms).

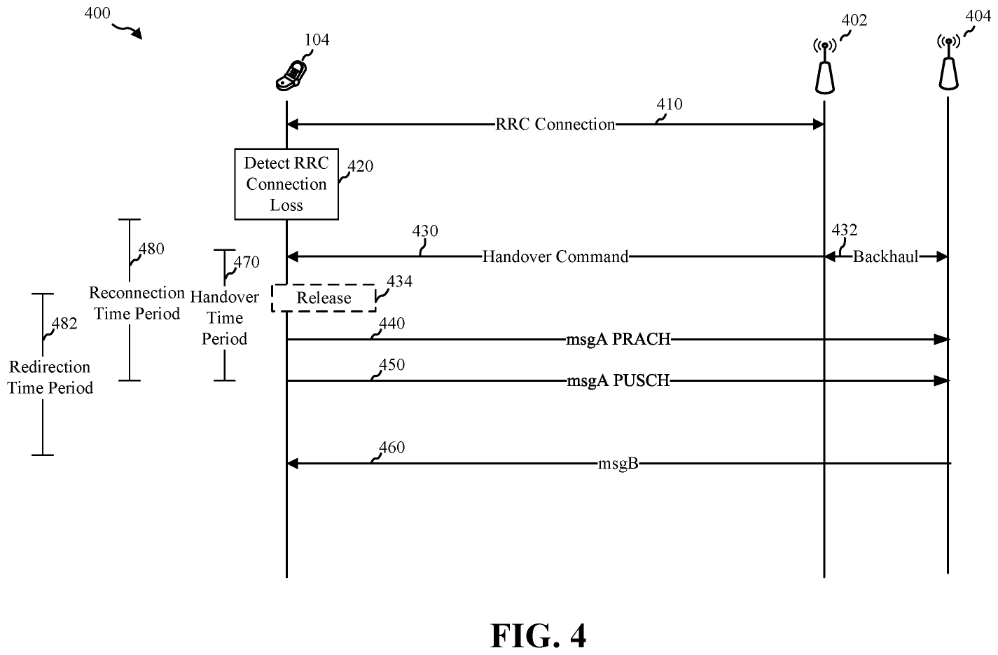

FIG. 4 is a message diagram 400 including messages that may be transmitted to establish a connection for a UE 104 to a base station 402 or a base station 404. The UE 104 may initially have an RRC connection 410 with the base station 402, which may be an example of the base station 102. The base station 402 may be referred to as the serving cell, pCell, or serving base station. The base station 402 may also be the pCell of a master cell group (MCG).

At block 420, in one aspect of the present disclosure, the UE 104 may determine that the RRC connection 410 has been lost. For example, the UE 104 may detect a condition indicating that the RRC connection 410 has been lost. Example conditions include: radio link failure of the MCG, re-configuration with sync failure of the MCG, mobility from NR failure, integrity check failure, or RRC connection reconfiguration failure. In response to determining that the RRC connection 410 has been lost, the UE 104 may determine to attempt to re-establish the RRC connection 410 with the same serving cell (e.g., base station 402) or another base station (e.g., base station 404).

In another aspect of the present disclosure, the serving base station 402 may transmit a handover command 430, and the UE 104 may receive the handover command 430. The handover command 430 may instruct the UE 104 to change to the base station 404, which may be referred to as a target cell or target base station. In an aspect, the handover command 430 may include a contention free random access (CFRA) preamble that the UE 104 may use to establish a connection with the target base station 404. In some implementations, the handover command 430 may be a RRC connection release with redirection command. In block 434, the UE 104 may release the RRC connection 410 in response to the RRC connection release with redirection command.

In an aspect, the serving base station 402 and the target base station 404 may communicate via a backhaul 432 regarding the handover. For example, the serving base station 402 and the target base station 404 may share the CFRA preamble. The target base station 404 may reserve the CFRA preamble for the UE 104.

In response to either detecting the RRC connection loss at block 420 or receiving the handover command 430, the UE 104 may attempt to establish a connection with one of the base station 402 or the base station 404. In the case of a handover, the target base station 404 may be indicated by the handover command 430. In the case of detecting the RRC connection loss at block 420, the UE 104 may select a strongest base station with which to re-establish the connection. In either case, the UE 104 may use a RACH procedure to establish the connection. In particular, for the 2-step RACH procedure, the UE 104 may transmit the msgA PRACH 440. In an aspect, where the UE 104 has been provided with a CFRA preamble, the msgA PRACH 440 may be the CFRA preamble. Otherwise, the UE 104 may select a RACH preamble based on the RACH opportunity. The target base station 404 may receive the msgA PRACH 440.

As noted above, the 2-step RACH procedure also includes a RACH payload for the msgA. Accordingly, the UE 104 may transmit a msgA PUSCH 450 for the RACH payload. The UE 104 may transmit the msgA PUSCH 450 on resources of the target base station 404 designated for the RACH msgA PUSCH 450. The target base station 404 may receive the RACH msgA PUSCH 450.

The target base station 404 may transmit the msgB 460 to complete the 2-step RACH procedure. For example, the base station 404 may transmit the msgB 460 on the PDSCH.

In an aspect, a time period for performing the connection establishment (e.g., handover or re-establishment) may be defined based on a time for transmitting msgA of the 2-step RACH procedure. For example, a handover time period 470 may be defined between the time that the handover command 430 is received and the time that the UE 104 is able to transmit the msgA PRACH and the msgA PUSCH 450. Similarly, a reconnection time period 480 may be defined between the time that the UE 104 detects the RRC connection loss at block 420 and the time that the UE 104 is able to transmit the msgA PRACH and the msgA PUSCH 450. A redirection time period 482 may be defined between the time that the UE 104 releases the RRC connection 410 in block 434 and the time that the UE 104 is able to transmit the msgA PRACH and the msgA PUSCH 450. A first time period may refer to any of the handover time period 470, the reconnection time period 480, or the redirection time period 482.

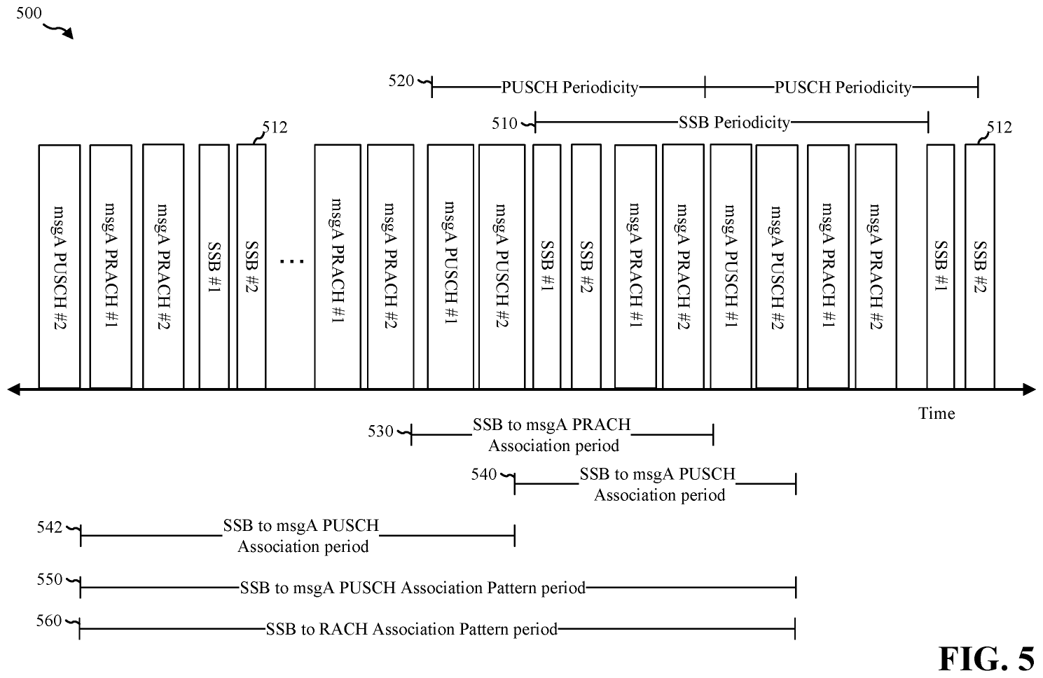

FIG. 5 is a resource diagram 500 including resources for SSBs, PRACH, and PUSCH. In an aspect, the SSBs, PRACH, and PUSCH may share a pool of resources (e.g., frequency domain resources) and have different periodicities. For example, SSBs may be transmitted with an SSB periodicity 510 and resources for a msgA PUSCH may be designated with a PUSCH periodicity 520. A PUSCH resource may denote one or more combinations of time, frequency, and DMRS preamble sequence of msgA PUSCH.

A SSB to msgA PRACH association period 530 may be a time period after which a SSB to msgA PRACH association pattern repeats. The time for a UE 104 to transmit a msgA PRACH 440 may depend on the SSB to msgA PRACH association period 530. For example, the SSB to msgA PRACH association period 530 may result in interruption uncertainty. That is, when the UE 104 detects the loss of RRC connection or receives the handover command 430, the UE 104 may be uncertain of a current time within the SSB to msgA PRACH association period 530. Accordingly, the handover time period 470 and the reconnection time period 480 may depend on the SSB to msgA PRACH association period 530 because the UE 104 may need to wait for an available PRACH opportunity. The SSB to msgA PRACH association period 530 may also be referred to as a SSB to RACH association period.

Similarly, an SSB to msgA PUSCH association period 540 may be a time period after which a SSB to msgA PUSCH association pattern repeats. The time for a UE 104 to transmit a msgA PUSCH 450 may depend on the SSB to msgA PUSCH association period 540. For example, the SSB to msgA PUSCH association period 540 may also result in interruption uncertainty. That is, when the UE 104 detects the loss of RRC connection or receives the handover command 430, the UE 104 may be uncertain of a current time within the SSB to msgA PUSCH association period 540. Accordingly, the handover time period 470 and the reconnection time period 480 may depend on the SSB to msgA PUSCH association period 540 because the UE 104 may need to wait for an available PUSCH resource.

The SSB to msgA PUSCH association period 540 may depend on various parameters of the configuration of a cell. For example, the SSB to msgA PUSCH association period 540 may depend on one or more of: a number of actually transmitted SSBs, a number of PRACH occasions in a frame, or a number of PUSCH occasions in a frame.

Due to the different periodicities of SSB periodicity 510 and the PUSCH periodicity 520, the resources for SSBs and msgA PUSCH may at least partially overlap, and some msgA PUSCH resources may be invalidated in favor of SSBs. For example, the SSB 512 may be transmitted by the target base station 404 at a time where a msgA PUSCH resource would otherwise be available. Accordingly, where the msgA PUSCH resource is unavailable, a SSB to msgA PUSCH association period 542 may occur. The SSB to msgA PUSCH association period 542 may have a different duration (e.g., longer) than the SSB to msgA PUSCH association period 540. That is, the duration of the SSB to msgA PUSCH association period may change. In an aspect, a SSB to msgA PUSCH association pattern period 550 may be defined as a period over which a mapping pattern between SSB and msgA PUSCH is guaranteed to repeat after every SSB to msgA PUSCH association period 540, 542. The SSB to msgA PUSCH association pattern period 550 may, for example, be the sum of each unique SSB to msgA PUSCH association period 540, 542. Accordingly, in an aspect, the handover time period 470 and the reconnection time period 480 may depend on the SSB to msgA PUSCH association pattern period 550.

A SSB to RACH association pattern period 560 may include one or more association periods and may be determined so that a pattern between PRACH occasions and SSBs repeats at most every 160 msec. Interruption uncertainty may be defined as the minimum time period that guarantees the presence of a valid msgA-PRACH and msgA-PUSCH occasion in the new cell. This minimum time period may be equal to the SSB to RACH association pattern period 560. The SSB to RACH association pattern period 560 may allow the UE to find a valid PRACH resource and valid PUSCH resource for the target cell. The SSB to RACH association pattern period 560 may include multiple SSB to RACH association periods 530. A value of the SSB to RACH association pattern period 560 may be a fixed time period. For example, the value of the SSB to RACH association pattern period 560 may be defined by a standards document or regulation. In some implementations, the fixed time period may be 160 ms.

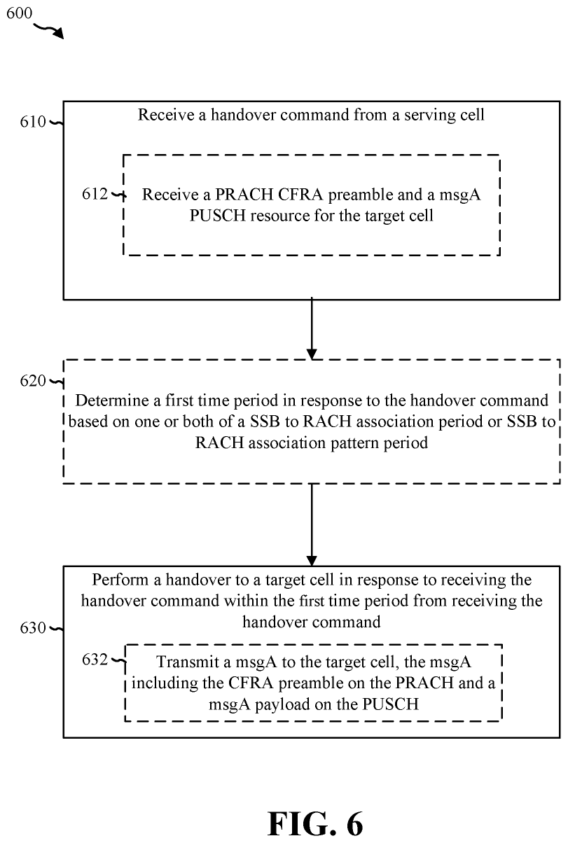

FIG. 6 is a flowchart of an example method 600 for performing a handover. The method 600 may be performed by a UE (e.g., UE 104) including a connection component 140. Optional blocks are illustrated with dashed lines.

At block 610, the method 600 may include receiving a handover command from a serving cell. In an aspect, for example, the UE 104, controller/processor 359, processor 1012, and/or the modem 1014 may execute the connection component 140 and/or handover component 142 to receive the handover command 430 from the serving cell (e.g., serving base station 402). Thus, the UE 104, controller/processor 359, processor 1012, and/or the modem 1014 executing the connection component 140 or handover component 142 or one of its subcomponents may define means for receiving a handover command from a serving cell.

In an aspect, at sub-block 612, the block 610 may optionally include receiving a PRACH CFRA preamble and a msgA PUSCH resource for the target cell. For example, the handover component 142 may receive the PRACH CFRA preamble and a msgA PUSCH resource for the target cell in the handover command 430.

At block 620, the method 600 may optionally include determining a first time period in response to receiving the handover command based on one or both of a SSB to RACH association period or a SSB to RACH association pattern period. In an aspect, for example, the UE 104, controller/processor 359, processor 1012, and/or the modem 1014 may execute the connection component 140 and/or the timing component 146 to determine the handover time period 470 in response to receiving the handover command 430 based on one or both of a SSB to RACH association period 530 or a SSB to RACH association pattern period 560. The timing component 146 may determine the handover time period 470 based on the SSB to RACH association pattern period 560. For example, the SSB to RACH association pattern period 560 may include one or more of the SSB to msgA PRACH association period 530 or the SSB to msgA PUSCH association pattern period 550 in addition to the SSB to msgA PUSCH association period 540. In some implementations, the value of the SSB to RACH association pattern period 560 is a fixed time period. For example, the fixed time period may be 160 ms. Thus, the UE 104, controller/processor 359, processor 1012, and/or the modem 1014 executing the connection component 140 or timing component 146 or one of its subcomponents may define means for determining a first time period.

At block 630, the method 600 may include performing a handover to a target cell in response to the handover command within the first time period from receiving the handover command. In an aspect, for example, the UE 104, controller/processor 359, processor 1012, and/or the modem 1014 may execute the connection component 140 and/or the RACH component 148 to perform the handover to the target cell (e.g., target base station 404) in response to receiving the handover command 430 within the handover time period 470 from receiving the handover command 430. Thus, the UE 104, controller/processor 359, processor 1012, and/or the modem 1014 executing the connection component 140 or RACH component 148 or one of its subcomponents may define means for performing a handover to a target cell.

In an aspect, at sub-block 632, the block 630 may optionally include transmitting a msgA to the target cell, the msgA including the CFRA preamble on the PRACH and a msgA payload on the PUSCH. For example, the RACH component 148 may transmit the msgA to the target cell, the msgA including the CFRA preamble on the PRACH (e.g., as msgA PRACH 440) and a msgA payload on the PUSCH (e.g., as msgA PUSCH 450).

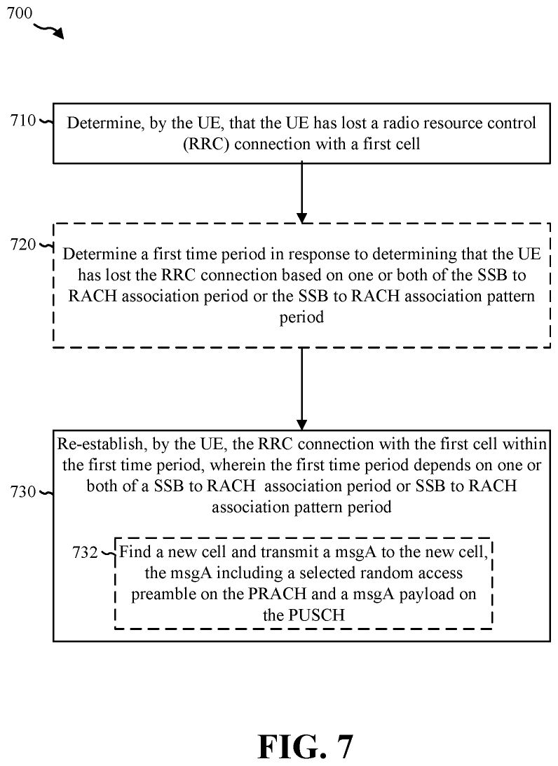

FIG. 7 is a flowchart of an example method 700 for performing a connection re-establishment. The method 700 may be performed by a UE (e.g., UE 104) including a connection component 140.

At block 710, the method 700 may include determining, by the UE, that the UE has lost a radio resource control (RRC) connection with a first cell. In an aspect, for example, the UE 104, controller/processor 359, processor 1012, and/or the modem 1014 may execute the connection component 140 and/or the failure component 144 to determine that the UE 104 has lost the RRC connection 410 with a first cell (e.g., base station 402). Thus, the UE 104, controller/processor 359, processor 1012, and/or the modem 1014 executing the connection component 140 or failure component 144 or one of its subcomponents may define means for determining that the UE has lost a RRC connection with a first cell.

At block 720, the method 700 may optionally include determining a first time period in response to determining that the UE has lost the RRC connection based on one or both of a SSB to RACH association period or a SSB to RACH association pattern period. In an aspect, for example, the UE 104, controller/processor 359, processor 1012, and/or the modem 1014 may execute the connection component 140 and/or timing component 146 to determine the reconnection time period 480 in response to determining that the UE 104 has lost the RRC connection 410 based on the SSB to msgA PUSCH association period 540. The timing component 146 may determine the reconnection time period 480 based on the SSB to RACH association pattern period 560. For example, the SSB to RACH association pattern period 560 may include one or more of the SSB to msgA PRACH association period 530 or the SSB to msgA PUSCH association pattern period 550 in addition to the SSB to msgA PUSCH association period 540. In some implementations, the value of the SSB to RACH association pattern period 560 is a fixed time period. For example, the fixed time period may be 160 ms. Thus, the UE 104, controller/processor 359, processor 1012, and/or the modem 1014 executing the connection component 140 or timing component 146 or one of its subcomponents may define means for determining the first time period.

At block 730, the method 700 may include re-establishing, by the UE, the RRC connection with the first cell within a first time period. In an aspect, for example, the UE 104, controller/processor 359, processor 1012, and/or the modem 1014 may execute the connection component 140 and/or the RACH component 148 to re-establish the RRC connection 410 with the first cell (e.g., base station 402) within the reconnection time period 480. The reconnection time period 480 may depend on one or both of the SSB to RACH association period 530 or the SSB to RACH association pattern period 560. Thus, the UE 104, controller/processor 359, processor 1012, and/or the modem 1014 executing the connection component 140 or RACH component 148 or one of its subcomponents may define means for re-establishing the RRC connection with the first cell within the first time period.

In an aspect, at sub-block 732, the block 730 may optionally include transmitting a msgA to the target cell, the msgA including a selected random access preamble on the PRACH and a msgA payload on the PUSCH. For example, the RACH component 148 may transmit the msgA to the target cell, the msgA including the selected random access preamble on the PRACH (e.g., as msgA PRACH 440) and a msgA payload on the PUSCH (e.g., as msgA PUSCH 450).

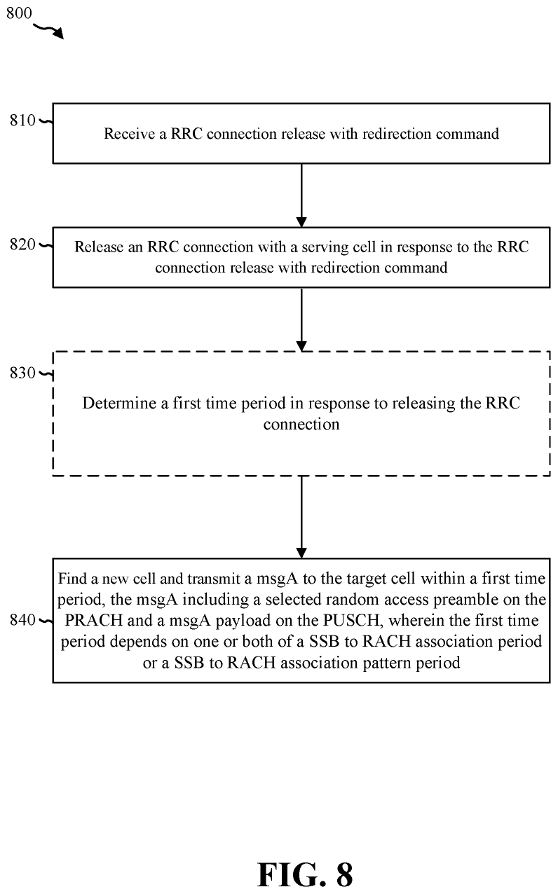

FIG. 8 is a flowchart of an example method 800 for connecting to a new cell following a release with redirection. The method 800 may be performed by a UE (e.g., UE 104) including a connection component 140.

At block 810, the method 700 may include receiving a RRC connection release with redirection command. In an aspect, for example, the UE 104, controller/processor 359, processor 1012, and/or the modem 1014 may execute the connection component 140 and/or the handover component 142 to receive a RRC connection release with redirection command (e.g., as an example of a handover command 430). Thus, the UE 104, controller/processor 359, processor 1012, and/or the modem 1014 executing the connection component 140 or handover component 142 or one of its subcomponents may define means for receiving a RRC connection release with redirection command.

At block 820, the method 800 may include releasing an RRC connection with a serving cell in response to the RRC connection release with redirection command. In an aspect, for example, the UE 104, controller/processor 359, processor 1012, and/or the modem 1014 may execute the connection component 140 and/or failure component 144 to release the RRC connection 410 with the serving cell (e.g., base station 402) in response to the RRC connection release with redirection command (e.g., as an example of the handover command 430). Thus, the UE 104, controller/processor 359, processor 1012, and/or the modem 1014 executing the connection component 140 or failure component 144 or one of its subcomponents may define means for releasing an RRC connection with a serving cell in response to the RRC connection release with redirection command.

At block 830, the method 800 may optionally include determining a first time period in response to releasing the RRC connection. In an aspect, for example, the UE 104, controller/processor 359, processor 1012, and/or the modem 1014 may execute the connection component 140 and/or timing component 146 to determine a first time period in response to releasing the RRC connection. For example, the timing component 146 may determine the redirection time period 482 based on one or both of a SSB to RACH association period 530 or a SSB to RACH association pattern period 560. The SSB to RACH association period 560 may include one or more of the SSB to msgA PRACH association period 530 or the SSB to msgA PUSCH association pattern period 550 in addition to the SSB to msgA PUSCH association period 540. Thus, the UE 104, controller/processor 359, processor 1012, and/or the modem 1014 executing the connection component 140 or timing component 146 or one of its subcomponents may define means for determining a first time period in response to releasing the RRC connection.

At block 840, the method 800 may include finding a new cell and transmitting a msgA to the target cell within a first time period, the msgA including a selected random access preamble on the PRACH and a msgA payload on the PUSCH, wherein the first time period depends on a SSB to RACH association period. In an aspect, for example, the UE 104, controller/processor 359, processor 1012, and/or the modem 1014 may execute the connection component 140 and/or the RACH component 148 to find a new cell and transmit a msgA to the target cell within a first time period, the msgA including a selected random access preamble on the PRACH and a msgA payload on the PUSCH, wherein the first time period depends on one or both of a SSB to RACH association period 530 or a SSB to RACH association pattern period 560. The reconnection time period 480 may also depend on the SSB to msgA PUSCH association period 540. Thus, the UE 104, controller/processor 359, processor 1012, and/or the modem 1014 executing the connection component 140 or RACH component 148 or one of its subcomponents may define means for finding a new cell and transmitting a msgA to the target cell within a first time period, the msgA including a selected random access preamble on the PRACH and a msgA payload on the PUSCH, wherein the first time period depends on one or both of a SSB to RACH association period or a SSB to RACH association pattern period.

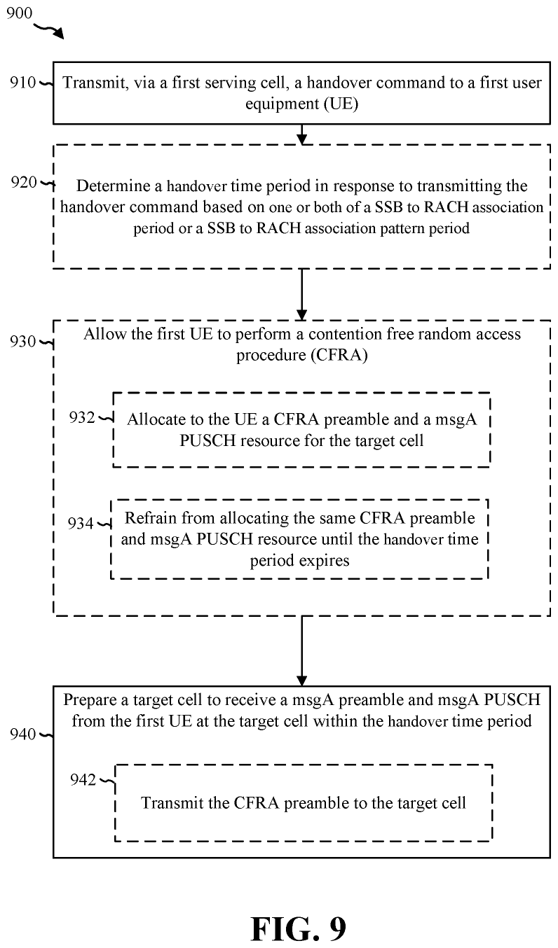

FIG. 9 is a flowchart of an example method 900 for performing a handover. The method 900 may be performed by network (e.g., access network 100) including a first base station 402 as a serving cell and a second base station 404 as a target cell, each including a RACH component 198.

At block 910, the method 900 may include transmitting, via a first serving cell, a handover command to a user equipment (UE). In an aspect, for example, the base station 102/402, the controller/processor 375, the processor 1112 and/or the modem 1114 may execute the handover component 198 and/or the command component 1142 to transmit, via the first serving cell, a handover command to a first user equipment (UE). Thus, the base station 102/402, he controller/processor 375, the processor 1112 and/or the modem 1114 executing the handover component 198 or command component 1142 or one of its subcomponents may define means for transmitting, via a first serving cell, a handover command to a UE.

At block 920, the method 900 may optionally include determining a first time period in response to the handover command based on one or both of a SSB to RACH association period or a SSB to RACH association pattern period. In an aspect, for example, the base station 102/402, the controller/processor 375, the processor 1112 and/or the modem 1114 may execute the handover component 198 and/or the timing component 1144 to determine the handover time period 470 in response to the handover command based on one or both of a SSB to RACH association period 530 or a SSB to RACH association pattern period 560. For example, the SSB to RACH association pattern period 560 may include one or more of the SSB to msgA PRACH association period 530 or the SSB to msgA PUSCH association pattern period 550 in addition to the SSB to msgA PUSCH association period 540. Thus, the base station 102/402, he controller/processor 375, the processor 1112 and/or the modem 1114 executing the handover component 198 or timing component 1144 or one of its subcomponents may define means for determining the first time period.

At block 930, the method 900 may include allowing the UE to perform a CFRA procedure. In an aspect, for example, the base station 102/402, the controller/processor 375, the processor 1112 and/or the modem 1114 may execute the handover component 198 and/or the RACH component 1146 to allow the first UE to perform a contention free random access (CFRA) procedure. Thus, the base station 102/402, the controller/processor 375, the processor 1112 and/or the modem 1114 executing the handover component 198 or timing component 1144 or one of its subcomponents may define means for allowing the UE to perform a CFRA procedure.

In an aspect, at sub-block 932, the block 930 may include allocating to the UE a CFRA preamble and a msgA PUSCH resource for the second target cell. For example, the RACH component 1146 may allocate to the UE 104 a CFRA preamble and a msgA PUSCH resource for the second target cell (e.g., base station 404). That is, the RACH component 1146 may reserve the CFRA preamble and msgA PUSCH resource for the UE 104.

In an aspect, at sub-block 934, the block 930 may include refraining from allocating the same CFRA preamble and msgA PUSCH resource until the first time period expires. For example, the RACH component 1146 may refrain from allocating the same CFRA preamble and msgA PUSCH resource until the first time period (e.g., handover time period 470) expires. That is, the RACH component 1146 may hold the reservation of the CFRA preamble and msgA PUSCH resource for the UE 104 for the duration of the handover time period 470.

At block 940, the method 900 may include preparing a target cell to receive a msgA preamble and msgA PUSCH from the UE at the target cell within the handover time period. In an aspect, for example, the base station 102/402, the controller/processor 375, the processor 1112 and/or the modem 1114 may execute the handover component 198 and/or the backhaul component 1148 to prepare the target cell (e.g., base station 404) to receive a msgA preamble and msgA PUSCH from the first UE at the target cell within the handover time period. For example, the base station 102/402, EPC 160, or 5GC 190 may transfer a UE context to the base station 404. For example, in an aspect, at sub-block 942, the block 940 may include transmitting the CFRA preamble to the second target cell. For example, the backhaul component 1148 may transmit the CFRA preamble to the target cell (e.g., target base station 404) via the backhaul 432. Accordingly, the target cell may identify the UE 104 based on the CFRA preamble. Thus, the base station 102/402, the controller/processor 375, the processor 1112 and/or the modem 1114 executing the handover component 198 or backhaul component 1148 or one of its subcomponents may define means for preparing a target cell to receive a msgA preamble and msgA PUSCH from the UE.

Referring to FIG. 10, one example of an implementation of UE 104 may include a variety of components, some of which have already been described above, but including components such as one or more processors 1012 and memory 1016 and transceiver 1002 in communication via one or more buses 1044, which may operate in conjunction with modem 1014, and connection component 140 to enable one or more of the functions described herein related to updating one or more SPS configurations and/or CGs. Further, the one or more processors 1012, modem 1014, memory 1016, transceiver 1002, RF front end 1088 and one or more antennas 1065 may be configured to support voice and/or data calls (simultaneously or non-simultaneously) in one or more radio access technologies. The antennas 1065 may include one or more antennas, antenna elements, and/or antenna arrays.

In an aspect, the one or more processors 1012 may include a modem 1014 that uses one or more modem processors. The various functions related to connection component 140 may be included in modem 1014 and/or processors 1012 and, in an aspect, may be executed by a single processor, while in other aspects, different ones of the functions may be executed by a combination of two or more different processors. For example, in an aspect, the one or more processors 1012 may include any one or any combination of a modem processor, or a baseband processor, or a digital signal processor, or a transmit processor, or a receiver processor, or a transceiver processor associated with transceiver 1002. In other aspects, some of the features of the one or more processors 1012 and/or modem 1014 associated with connection component 140 may be performed by transceiver 1002.

Also, memory 1016 may be configured to store data used herein and/or local versions of applications 1075, connection component 140 and/or one or more of subcomponents thereof being executed by at least one processor 1012. Memory 1016 may include any type of computer-readable medium usable by a computer or at least one processor 1012, such as random access memory (RAM), read only memory (ROM), tapes, magnetic discs, optical discs, volatile memory, non-volatile memory, and any combination thereof. In an aspect, for example, memory 1016 may be a non-transitory computer-readable storage medium that stores one or more computer-executable codes defining connection component 140 and/or one or more of subcomponents thereof, and/or data associated therewith, when UE 104 is operating at least one processor 1012 to execute connection component 140 and/or one or more subcomponents thereof.

Transceiver 1002 may include at least one receiver 1006 and at least one transmitter 1008. Receiver 1006 may include hardware, firmware, and/or software code executable by a processor for receiving data, the code comprising instructions and being stored in a memory (e.g., computer-readable medium). Receiver 1006 may be, for example, a radio frequency (RF) receiver. In an aspect, receiver 1006 may receive signals transmitted by at least one base station 102. Additionally, receiver 1006 may process such received signals, and also may obtain measurements of the signals, such as, but not limited to, Ec/Io, SNR, RSRP, RSSI, etc. Transmitter 1008 may include hardware, firmware, and/or software code executable by a processor for transmitting data, the code comprising instructions and being stored in a memory (e.g., computer-readable medium). A suitable example of transmitter 1008 may including, but is not limited to, an RF transmitter.

Moreover, in an aspect, UE 104 may include RF front end 1088, which may operate in communication with one or more antennas 1065 and transceiver 1002 for receiving and transmitting radio transmissions, for example, wireless communications transmitted by at least one base station 102 or wireless transmissions transmitted by UE 104. RF front end 1088 may be connected to one or more antennas 1065 and may include one or more low-noise amplifiers (LNAs) 1090, one or more switches 1092, one or more power amplifiers (PAs) 1098, and one or more filters 1096 for transmitting and receiving RF signals.

In an aspect, LNA 1090 may amplify a received signal at a desired output level. In an aspect, each LNA 1090 may have a specified minimum and maximum gain values. In an aspect, RF front end 1088 may use one or more switches 1092 to select a particular LNA 1090 and its specified gain value based on a desired gain value for a particular application.

Further, for example, one or more PA(s) 1098 may be used by RF front end 1088 to amplify a signal for an RF output at a desired output power level. In an aspect, each PA 1098 may have specified minimum and maximum gain values. In an aspect, RF front end 1088 may use one or more switches 1092 to select a particular PA 1098 and its specified gain value based on a desired gain value for a particular application.

Also, for example, one or more filters 1096 may be used by RF front end 1088 to filter a received signal to obtain an input RF signal. Similarly, in an aspect, for example, a respective filter 1096 may be used to filter an output from a respective PA 1098 to produce an output signal for transmission. In an aspect, each filter 1096 may be connected to a specific LNA 1090 and/or PA 1098. In an aspect, RF front end 1088 may use one or more switches 1092 to select a transmit or receive path using a specified filter 1096, LNA 1090, and/or PA 1098, based on a configuration as specified by transceiver 1002 and/or processor 1012.

As such, transceiver 1002 may be configured to transmit and receive wireless signals through one or more antennas 1065 via RF front end 1088. In an aspect, transceiver 1002 may be tuned to operate at specified frequencies such that UE 104 can communicate with, for example, one or more base stations 102 or one or more cells associated with one or more base stations 102. In an aspect, for example, modem 1014 may configure transceiver 1002 to operate at a specified frequency and power level based on the UE configuration of the UE 104 and the communication protocol used by modem 1014.

In an aspect, modem 1014 may be a multiband-multimode modem, which can process digital data and communicate with transceiver 1002 such that the digital data is sent and received using transceiver 1002. In an aspect, modem 1014 may be multiband and be configured to support multiple frequency bands for a specific communications protocol. In an aspect, modem 1014 may be multimode and be configured to support multiple operating networks and communications protocols. In an aspect, modem 1014 may control one or more components of UE 104 (e.g., RF front end 1088, transceiver 1002) to enable transmission and/or reception of signals from the network based on a specified modem configuration. In an aspect, the modem configuration may be based on the mode of the modem and the frequency band in use. In another aspect, the modem configuration may be based on UE configuration information associated with UE 104 as provided by the network during cell selection and/or cell reselection.

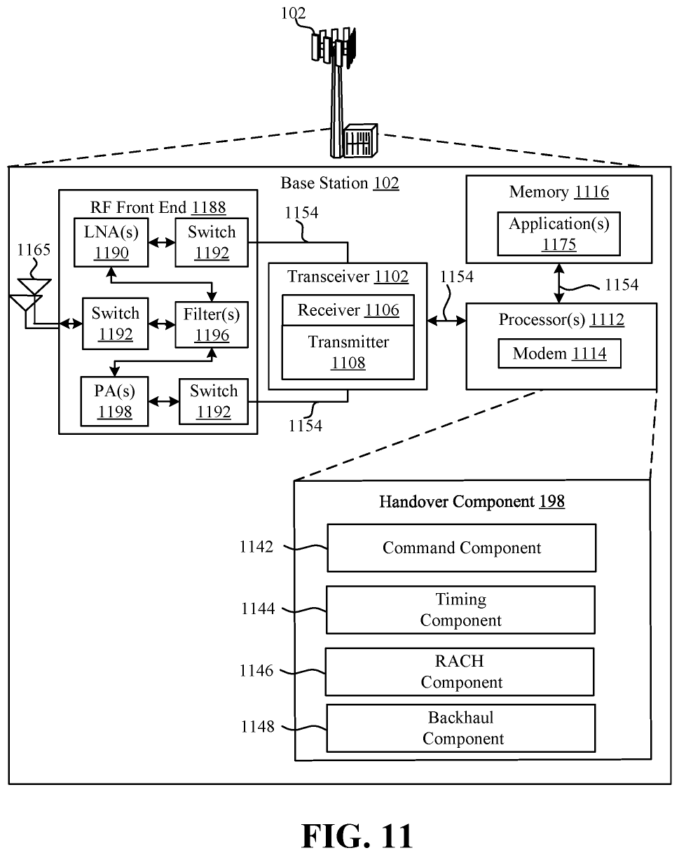

Referring to FIG. 11, one example of an implementation of base station 102 may include a variety of components, some of which have already been described above, but including components such as one or more processors 1112 and memory 1116 and transceiver 1102 in communication via one or more buses 1154, which may operate in conjunction with modem 1114 and handover component 198 to enable one or more of the functions described herein related to updating scheduling configurations.

The transceiver 1102, receiver 1106, transmitter 1108, one or more processors 1112, memory 1116, applications 1175, buses 1154, RF front end 1188, LNAs 1190, switches 1192, filters 1196, PAs 1198, and one or more antennas 1165 may be the same as or similar to the corresponding components of UE 104, as described above, but configured or otherwise programmed for base station operations as opposed to UE operations.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Some Further Example Implementations

A first example method of wireless communication for a user equipment (UE), comprising: receiving a handover command from a serving cell; and performing a handover to a target cell in response to the handover command within a first time period from the handover command, wherein performing the handover includes transmitting a physical random access channel (PRACH) preamble and a physical uplink shared channel (PUSCH) to the target cell, wherein the first time period depends on one or both of a synchronization signal block (SSB) to random access (RACH) association period or a SSB to RACH association pattern period.

The above first example method further comprising determining the first time period in response to receiving the handover command based on one or both of the SSB to RACH association period or the SSB to RACH association pattern period.

Any of the above first example methods, wherein the handover time period also depends on a SSB to msgA PUSCH association pattern period.

Any of the above first example methods, wherein receiving the handover command comprises receiving a PRACH contention free random access procedure (CFRA) preamble and a msgA PUSCH resource for the target cell.

Any of the above first example methods, wherein performing the handover comprises transmitting a msgA to the target cell, the msgA including the CFRA preamble on the PRACH and a msgA payload on the PUSCH.

Any of the above first example methods, wherein a value of the SSB to RACH association pattern period is a fixed time period.

Any of the above first example methods, wherein the fixed time period is 160 ms.

Any of the above first example methods, wherein the SSB to RACH association pattern period allows the UE to find a valid PRACH resource and a valid PUSCH resource for the target cell.

Any of the above first example methods, wherein the UE transmits the PUSCH after the PRACH and does not receive any downlink transmission from the target cell between transmitting the PRACH and the PUSCH.

Any of the above first example methods, wherein the SSB to RACH association pattern period comprises multiple SSB to RACH association periods.

A first example apparatus for wireless communication, comprising: a memory; and at least one processor coupled to the memory and configured to: perform any of the above first example methods.

A second example apparatus for wireless communication, comprising means for performing any of the above first example methods.

A first example non-transitory computer-readable medium storing computer executable code, the code when executed by a processor cause the processor to perform any of the above first example methods.

A second example method of wireless communications for a user equipment (UE), comprising: determining that the UE has lost a radio resource control (RRC) connection with a first cell; and re-establishing the RRC connection within a first time period, wherein the first time period depends on one or both of a synchronization signal block (SSB) to random access (RACH) association period or a SSB to RACH association pattern period.

The above second example method, wherein re-establishing the RRC connection comprises finding a new cell and transmitting a msgA to the new cell, wherein the msgA includes a selected random access preamble on a physical random access channel (PRACH) and a msgA payload on a physical uplink shared channel (PUSCH).

Any of the above second example methods, further comprising determining the first time period in response to determining that the UE has lost the RRC connection based on one or both of the SSB to RACH association period or the SSB to RACH association pattern period.

Any of the above second example methods, wherein the first time period also depends on a SSB to msgA PUSCH association pattern period.

Any of the above second example methods, wherein a value of the SSB to RACH association pattern period is a fixed time period.

Any of the above second example methods, wherein the fixed time period is 160 ms.

Any of the above second example methods, wherein the SSB to RACH association pattern period allows the UE to find a valid PRACH resource and a valid PUSCH resource for the new cell.

Any of the above second example methods, wherein the UE does not receive any downlink transmission from the new cell between transmitting the random access preamble on the PRACH and the msgA payload on the PUSCH.

A third example apparatus for wireless communication, comprising: a memory; and at least one processor coupled to the memory and configured to perform any of the above second example methods.

A fourth example apparatus for wireless communication, comprising means for performing any of the above second example methods.

A second example non-transitory computer-readable medium storing computer executable code, the code when executed by a processor cause the processor to perform any of the above second example methods.

A third example method of wireless communication comprising, at a user equipment (UE): receiving a radio resource control (RRC) connection release with redirection command; releasing an RRC connection with a serving cell in response to the RRC connection release with redirection command; and finding a new cell and transmitting a physical random access (PRACH) preamble and physical uplink shared channel (PUSCH) to the new cell within a first time period, wherein the first time period depends on one or both of a synchronization signal block (SSB) to random access (RACH) association period or a SSB to RACH association pattern period.

The above third example method, wherein a value of the SSB to RACH association pattern period is a fixed time period.

Any of the above third example methods, wherein the fixed time period is 160 ms.

Any of the above third example methods, wherein the SSB to RACH association pattern period allows the UE to find a valid PRACH resource and a valid PUSCH resource for the new cell.

Any of the above third example methods, wherein the UE does not receive any downlink transmission from the new cell between transmitting the PRACH preamble and transmitting the PUSCH.

Any of the above third example methods, wherein the SSB to RACH association pattern period comprises multiple SSB to RACH association periods.

A fifth example apparatus for wireless communication, comprising: a memory; and at least one processor coupled to the memory and configured to perform any of the above third example methods.

A sixth example apparatus for wireless communication, comprising means for performing any of the above third example methods.

A third example non-transitory computer-readable medium storing computer executable code, the code when executed by a processor cause the processor to perform any of the above third example methods.

A fourth example method of wireless communication for a network, comprising: transmitting, via a first serving cell, a handover command to a user equipment (UE); and preparing a target cell to receive a msgA preamble and msgA PUSCH from the UE at the target cell within a first time period, wherein the first time period depends on one or both of a synchronization signal block (SSB) to random access (RACH) association period of the target cell or a SSB to RAC association pattern period of the target cell.

The above fourth example method, further comprising allowing the UE to perform a contention free random access (CFRA) procedure.

Any of the above fourth example methods, wherein allowing the UE to perform the CFRA procedure includes: allocating to the UE a CFRA preamble and a msgA PUSCH resource for the target cell; and refraining from allocating the same CFRA preamble and msgA PUSCH resource until the first time period expires.

Any of the above fourth example methods, further comprising determining the first time period in response to the handover command based on the SSB to RACH association pattern period.

Any of the above fourth example methods, wherein a value of the SSB to RACH association pattern period is a fixed time period.

Any of the above fourth example methods, wherein the fixed time period is 160 ms.

A seventh example apparatus for wireless communication, comprising: a memory; and at least one processor coupled to the memory and configured to perform any of the above third example methods.

A sixth example apparatus for wireless communication, comprising means for performing any of the above third example methods.

A fourth example non-transitory computer-readable medium storing computer executable code, the code when executed by a processor cause the processor to perform any of the above fourth example methods.

What is claimed is:

1. A method of wireless communication for a user equipment (UE), comprising, at the UE:
receiving a handover command from a serving cell; and
performing a handover to a target cell in response to the handover command within a first time period from the handover command, wherein performing the handover includes transmitting a physical random access channel (PRACH) preamble and a physical uplink shared channel (PUSCH) to the target cell, wherein the first time period depends on one or both of a synchronization signal block (SSB) to random access (RACH) association period or a SSB to RACH association pattern period.

2. The method of claim 1, further comprising determining the first time period in response to receiving the handover command based on one or both of the SSB to RACH association period or the SSB to RACH association pattern period.

3. The method of claim 1, wherein the handover time period also depends on a SSB to msgA PUSCH association pattern period.

4. The method of claim 1, wherein receiving the handover command comprises receiving a PRACH contention free random access procedure (CFRA) preamble and a msgA PUSCH resource for the target cell.

5. The method of claim 4, wherein performing the handover comprises transmitting a msgA to the target cell, the msgA including the CFRA preamble on the PRACH and a msgA payload on the PUSCH.

6. The method of claim 1, wherein a value of the SSB to RACH association pattern period is a fixed time period.

7. The method of claim 6, wherein the fixed time period is 160 ms.

8. The method of claim 1, wherein the SSB to RACH association pattern period allows the UE to find a valid PRACH resource and a valid PUSCH resource for the target cell.

9. The method of claim 1, wherein the UE transmits the PUSCH after the PRACH and does not receive any downlink transmission from the target cell between transmitting the PRACH and the PUSCH.

10. The method of claim 1, wherein the SSB to RACH association pattern period comprises multiple SSB to RACH association periods.

11. A method of wireless communications, comprising, at a user equipment (UE):
determining that the UE has lost a radio resource control (RRC) connection with a first cell; and
re-establishing the RRC connection within a first time period, wherein the first time period depends on one or both of a synchronization signal block (SSB) to random access (RACH) association period or a SSB to RACH association pattern period.

12. The method of claim 11, wherein re-establishing the RRC connection comprises finding a new cell and transmitting a msgA to the new cell, wherein the msgA includes a selected random access preamble on a physical random access channel (PRACH) and a msgA payload on a physical uplink shared channel (PUSCH).

13. The method of claim 12, wherein the SSB to RACH association pattern period allows the UE to find a valid PRACH resource and a valid PUSCH resource for the new cell.

14. The method of claim 12, wherein the UE does not receive any downlink transmission from the new cell between transmitting the random access preamble on the PRACH and the msgA payload on the PUSCH.

15. The method of claim 11, further comprising determining the first time period in response to determining that the UE has lost the RRC connection based on one or both of the SSB to RACH association period or the SSB to RACH association pattern period.

16. The method of claim 11, wherein a value of the SSB to RACH association pattern period is a fixed time period.

17. The method of claim 16, wherein the fixed time period is 160 ms.

18. The method of claim 11, wherein the SSB to RACH association pattern period comprises multiple SSB to RACH association periods.

19. A method of wireless communications, comprising, at a user equipment (UE):
receiving a radio resource control (RRC) connection release with redirection command;
releasing an RRC connection with a serving cell in response to the RRC connection release with redirection command; and
finding a new cell and transmitting a physical random access (PRACH) preamble and physical uplink shared channel (PUSCH) to the new cell within a first time period, wherein the first time period depends on one or both of a synchronization signal block (SSB) to random access (RACH) association period or a SSB to RACH association pattern period.

20. The method of claim 19, wherein a value of the SSB to RACH association pattern period is a fixed time period.

21. The method of claim 20, wherein the fixed time period is 160 ms.

22. The method of claim 19, wherein the SSB to RACH association pattern period allows the UE to find a valid PRACH resource and a valid PUSCH resource for the new cell.

23. The method of claim 19, wherein the UE does not receive any downlink transmission from the new cell between transmitting the PRACH preamble and transmitting the PUSCH.

24. The method of claim 19, wherein the SSB to RACH association pattern period comprises multiple SSB to RACH association periods.

25. A method of wireless communication for a network, comprising:
transmitting, via a first serving cell, a handover command to a user equipment (UE); and
preparing a target cell to receive a msgA preamble and msgA PUSCH from the UE at the target cell within a first time period, wherein the first time period depends on one or both of a synchronization signal block (SSB) to random access (RACH) association period of the target cell or a SSB to RACH association pattern period of the target cell.

26. The method of claim 25, further comprising allowing the UE to perform a contention free random access (CFRA) procedure.

27. The method of claim 26, wherein allowing the UE to perform the CFRA procedure includes:
allocating to the UE a CFRA preamble and a msgA PUSCH resource for the target cell; and
refraining from allocating the same CFRA preamble and the same msgA PUSCH resource until the first time period expires.

28. The method of claim 25, further comprising determining the first time period in response to the handover command based on one or both of the SSB to random access RACH association period of the target cell or the SSB to RACH association pattern period of the target cell.

29. The method of claim 25, wherein a value of the SSB to RACH association pattern period is a fixed time period.

30. The method of claim 29, wherein the fixed time period is 160 ms.
